(19) United States
(12) Patent Application Publication
(10) Pub. No.: US 2005/0201304 A1
(43) Pub. Date: Sep. 15, 2005

(54) Signaling mediation agent

(76) Inventor: Robert Olshansky, Wayland, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/800,116

(22) Filed: Mar. 12, 2004

(51) Int. Cl. H04B 1/44; H04L 12/423

(52) U.S. Cl. 370/282; 370/449

(57) ABSTRACT

A signaling mediation agent (SMA), facilitating communications among communication nodes by ensuring that signaling messages transmitted by the SMA have been modified so that they conform to the protocol variants used by the destination communication node. In one embodiment, the SMA also facilitates communications by ensuring that communication nodes on a private network are authenticated and authorized to receive various communication services, even if the communication nodes on the various networks use different communication protocols or variants of the same protocol.

The present invention relates to the field of communication and more specifically to facilitating communication between nodes within a private IP network, and between nodes on a private IP network 120 and nodes on an external IP network 125.

### BACKGROUND OF THE INVENTION

Referring to FIG. 1, enterprises, businesses, and even some consumers have deployed IP networks that provide IP services. These private networks 120 typically have attached nodes that are able to exchange IP packets between them across a physical wire or via a wireless connection. These private networks 120 also connect to external IP networks, such as the Internet, extranets, or VPNs, to enable nodes on the private network 120 to access services (e.g. web servers, email) provided by nodes on the external networks 125.

In addition to exchanging information packets associated with stored data, IP networks also exchange IP packets that carry real-time communication messages such as packetized voice (VoIP), packetized video, or instant messages. The messages are transmitted amongst IP devices on the private network 120 as well as between devices on the private network 120 and IP devices on external networks 125. The IP devices that are used for IP communications can be traditional desktop computers or laptops, or they can be devices such as IP phones or IP video terminals that are specifically design to provide IP communications services. Any such IP device attached to a network, either via a physical or a wireless connection, for purposes of sending or receiving communications services, shall hereinafter be referred to as a communication node (CN 105).

In addition to communication nodes that provide communications for single end-users, there are communication nodes that provide services for multiple users (herein referred to as “communications servers”). These communication servers provide traditional services (e.g. email, VoIP, instant messaging) as well as access to stored media (e.g. voicemail, video mail) or broadcast media (e.g. Internet radio, Internet video). Communication servers that serve multiple users could be, but are not limited to: call servers (e.g. IP-PBXs 190); conferencing bridges; interactive voice response systems (IVRs); or video mail servers.

The private network 120 must therefore provide interconnection amongst authorized users operating nodes or servers on the private network 120 as well as connecting nodes and services on the private network 120 to nodes and services on external networks 125.

Many homes and small office networks are connected to the Internet through DSL or cable modem connections. When a computer or communications device first attaches to the network, either through a direct wired connection or through a wireless connection, it must register with the private network 120 to obtain an internal IP address. Registration may require the presentation of a password or data that authenticates the device's identity and establishes that the device is authorized to attach to the private network 120. Once authenticated for network access, the device obtains an internal IP address. The IP address may be assigned permanently or it may be assigned dynamically by a DHCP server. The device may need to re-register whenever the device is rebooted, a network software application re-started, or the device is re-attached to the network.

To address IP assignment and Internet connection sharing, such networks often use a router 110 (or firewall 115) with network address translation (NAT) enabled. Though these NAT'ed routers 110 enable many devices, such as desktop computers, laptops, and IP phones to share a single external IP address, from the perspective of a device on the external network 125 the router 110 is the only device on the internal network. This causes interoperability problems when an external device wants to connect to an internal device. Firewalls 115 and other network devices intended to protect the private network 120 from unauthorized entry also present interoperability problems. Though these firewalls 115 and NAT devices are useful in protecting the internal network from intrusions, they also may block desired communications between an external node and an internal node.

For all of these communication nodes and services to function properly there must be interoperability between nodes on the private network, nodes on other private networks 120, and nodes on external networks 125 operated by the third-party service providers. Interoperability between nodes, however, is not assured. All of these IP communications rely on various standards, such as H.323 and SIP, which specify in detail the sequence of communication signals and the exact grammar and syntax that are needed to register nodes for communication services. The standards define how to establish, modify and terminate connections between one communication node 105 and another, or among several communication nodes. Examples of these standards, specifically pertaining to VoIP, include: the H.323 standard developed by the International Telecommunication Union (ITU), Session Initiation Protocol developed by the Internet Engineering Task Force (IETF), and the Media Gateway Control Protocol (MGCP) standard according to IETF RFC 2705.

While these standards are intended to ensure interoperability between communication nodes 105, the reality is that the standards continue to evolve and introduce changes and new methods. Additionally, the standards are not always sufficiently precise in defining syntax or fields, and frequently allow for alternative implementations. Software developers sometimes must even implement proprietary extensions or variants of the protocol to meet customer or vendor requirements. Therefore, IP devices on private networks 120 may use different protocols, or variations of a common protocol, when attempting to communicate amongst themselves and with external networks 125. These issues are addressed by the present invention.

### SUMMARY OF THE INVENTION

The present invention, a signaling mediation agent (SMA) 130, facilitates communication among communication nodes 105 by ensuring that signaling messages transmitted by the SMA 130 have been modified so that they conform to the protocol variants used by the destination communication node.

The SMA 130 also facilitates communication by ensuring that communication nodes 105 on a private network 120 are authenticated and authorized to receive various communication services, even if the communication nodes on the various networks use different communication protocols or variants of the same protocol.

An objective of the present invention is to provide a method for communication nodes 105 to communicate with each other, even if they use different standard or if they use different variants of the same standard.

Another objective of the present invention is to enable communication nodes 105 that can attach and re-attach to the private network 120 at different physical locations to register and authenticate themselves to both the private network 120 and external networks 125 in order to access communications services available on either the private or external networks 125. This ensures that unauthorized nodes cannot attach to the private network 120 or receive communications from either the private network 120 or external networks 125. Successful registration also assures that other nodes seeking to communicate with the first node are able to locate the first node because the first node has registered its address and other information with both the private network 120 and the external networks 125.

Another objective of the present invention is to enable devices attached to a private network 120 to communicate with devices attached to external networks 125 and to access communications services available on either the private network 120 or an external network 125. One aspect of this enabling includes mediating communications through firewall and network address translation (NAT) devices 115 that may be present between the internal network 120 and external networks 125.

### BRIEF DESCRIPTION OF THE DRAWINGS

FIG. 1 is network diagram illustrating a private network 120, a firewall, a NAT device 115, an IP router 110, an access circuit and an external network 125 as known in the prior art.

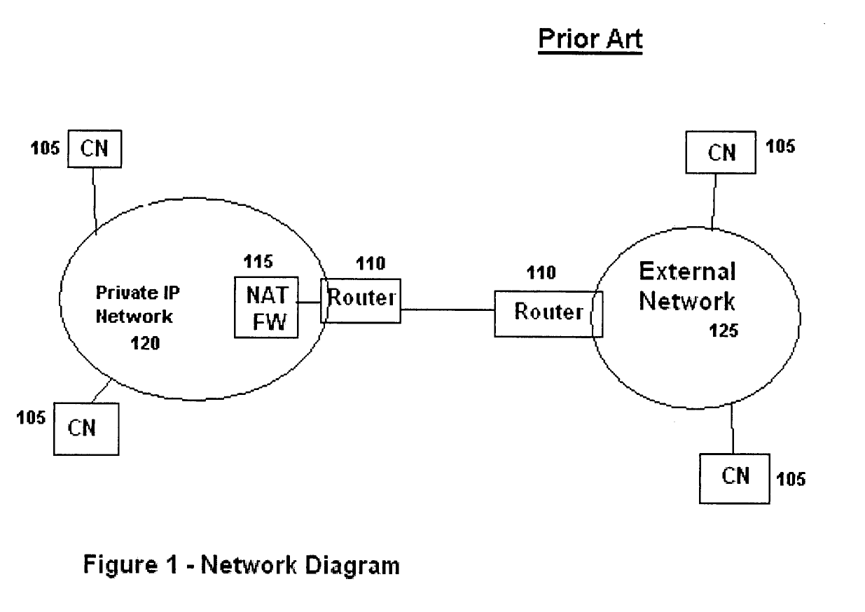

FIG. 2 is a diagram illustrating an embodiment of a SMA 130 according to the invention.

FIG. 3 is a diagram illustrating an embodiment of a private network 120 with three communication nodes, a communication node acting as a communication server 200, a SMA 130, a User Database 145, a Services Database 150, a Communications Node Database 155 and a Protocol Database 160, and a call server (IP-PBX 190) connected to a PSTN 195 in accordance with the present invention.

FIG. 4 illustrates an embodiment of the method using port numbers to identify the protocol variant used by a particular node in accordance with the present invention.

FIG. 5 is a diagram of an embodiment of a sequence of events related to a SMA 130.

FIG. 6 shows an embodiment of five communication nodes attached to an IP network 120 in accordance with the present invention.

### DETAILED DESCRIPTION OF A PREFERRED EMBODIMENT

The SMA 130 facilitates communication between nodes on a network and services those nodes may request. Generally, the SMA 130 comprises: a means for receiving communications and signaling messages 135, a Message Processor 140, a User Database 145, a Services Database 150, a Communication Node Database 155, a Protocol Database 160, a Protocol Mediation Processor 165, and a means for transmitting communications and signaling messages 170, each described in greater detail below.

1. Components

In some embodiments the SMA 130 is an application running on a single computer. In other embodiments, the SMA 130 is a plurality of applications that may run on one or more computers. These computer or computers may include dedicated systems or devices such as a call server, an IP-PBX 190, a network switch, a network router 110, a signaling proxy, a gatekeeper, or a server running various applications. Examples of such applications include, but are not limited to: an application that manages authentication of communication nodes, an application that manages registration of communication nodes for a particular service, or an application that assists in firewall/NAT traversal. In some embodiments, the SMA 130 is attached to the private network 120. In other embodiments, the SMA 130 is located on an external network 125.

The Message Processor 140 examines signals received by the SMA 130, checks authentication, node information, and allowable service information in the appropriate databases and passes the message onto the Protocol Mediation Processor 165. The Protocol Mediation Processor (PMP) 165 then applies any necessary modifications to the signal and sends the signal to the transmitting port for transmission. In addition, the PMP 165 may provide all the additional standard functionality of a signaling agent, such as an H.323 gatekeeper, a signaling routed gatekeeper, a SIP proxy or a SIP back-to-back user agent, as specified by the reference standard. The PMP 165 modifies signaling messages as specified by the signaling standard, but it also generates responses to signaling messages as specified by the signaling standard. In some embodiments, the standard signaling functions are provided by an external signaling agent, in other embodiments these functions are incorporated in the SMA 130.

Several databases are needed to support the SMA 130 as it processes registration requests and other signaling messages for communications. In some embodiments, these databases are separate databases. In other embodiments, the databases are contained within a single database comprising all the databases. The databases may reside on the SMA 130 itself or reside on separate computers. The database may also be stored in local memory on the SMA 130. In one embodiment there are four databases: the User Database 145, the Services Database 150, the CN Database 155, and the Protocol Database 160.

The User Database 145 contains a list of authorized users of communications services on the private network 120. In one embodiment, the User Database 145 has entries which may include: a username; a password; authentication data; a device type (e.g. an indication is the device is fixed or mobile); URIs; private telephone numbers; wireline public telephone numbers; cellular telephone numbers; private IP address or port numbers for signaling; device Ethernet address; device ID; or software ID. Additionally, fields may be added or removed as needed. One skilled in the art understands that this list of fields is not limited to having a one-to-one relationship with each other and that there are multiple possible schemas relating the entries.

For each communication node registered to the private network 120, the Services Database 150 contains a list of communications services which that node is authorized to use. In some embodiments, nodes are identified by the username and IP addresses registered to that node, or by only the username, or by only the IP address, or by some other identification system or alias specified by the network administrator 175. Node identification could also be based on the IP address or a combination of the IP address and the port number used for signaling.

The Communication Node Database 155 has a table listing the communication nodes that have been successfully registered to the private network 120. Each communication node has an entry in the table, containing information that identifies the communication node and the protocol variants it uses. CN 105 identification may include: a node alias, a unique device ID (such as a MAC address), an IP address, or a combination of IP address and port number for receiving signaling messages. For each CN 105 there is a field that identifies the protocol and protocol variant used by that node, e.g. Vendor A, Sip 2.0, Release 3.2(2). In some embodiments, the entries identifying the CN 105 can be made automatically by a feed from the User Database 145 once the CN 105 is registered. External services or communication nodes may be identified by a domain name or by specific IP address, set of addresses, or by a set of IP address masks that are used to access external services or communication nodes.

For each major protocol listed in the Communication Node Database (e.g. SIP 2.0) the Protocol Database 160 lists one or more particular implementation as the protocol reference specifications (PRS). The PRS is a set of mediation rules that instruct the PMP 165 how to construct a message so that it conforms to the structure of a specific protocol or variant. The PRS also may instruct the PMP 165 of a particular sequence of messages or message responses required for a particular protocol or variant. In a preferred embodiment there is only one PRS for each base protocol, but in some cases it is desirable to have more than one PRS.

It is expected that even with one protocol standard such as SIP, there are several variants of the standard including extensions both approved or unapproved by the standardizing body. Variations from the protocol reference specification (PRS) are identified based on the name of the vendor or software developer responsible for that implementation of the standard and by the release number of the software, or by a software alias. Variants of the PRS are recorded in the Protocol Database 160 based according to the vendor or developer of the communication node, the base signaling protocol and the version number of the software (e.g. Vendor A, SIP 2.0, 3.1(4)). The Protocol Database 160 contains a detailed specification of variations to the base protocol according to signaling method, field, syntax, punctuation, addressing format, grammar or any other specification that records how the variant in question differs from the PRS.

In one embodiment, protocol variants are identified by a protocol alias. In one embodiment, the network uses port numbers for signaling based on the protocol variant used by a node for communication. In this scenario, one such protocol alias is the TCP or UDP port number the communication nodes use for signaling.

Once a protocol and its specified variations from the PRS are recorded in the Protocol Database 160, and the Protocol Mediation Processor 165 verifies it is able to construct conforming signaling messages based on data in the Protocol Database 160, that protocol and its variations are described as certified. Certified protocols and their variants are authorized for use among nodes on the private network 120 or for communication between nodes on the private network 120 and nodes on external networks 125 or nodes on other private networks.

It is understood that the number of protocol variations authorized at any one moment in time can vary from time to time, and could be zero. The administrator 175 of the Protocol Database 160 has the authority to accept or reject variations to the PRS using the Protocol Certifier 180. The existence of a Protocol Database 160 enables the administrator 175 to either allow or deny authorization for the use of additional protocol variations at other moments in time.

To simplify the mediation of signaling it is useful for each type of signaling message (referred to as a signaling “method”) for each protocol variant to be separately certified as to whether that method as implemented conforms to the PRS. So for example in the case of the base protocol SIP 2.0, there are a number of methods and method extensions that have been standardized such as INVITE, ACK, BYE, REGISTER and others. For each protocol variant it is likely that many of the methods implemented by the variants are identical to the PRS and such messages do not require mediation.

Example 1: The SMA 130 uses different port addresses for receiving signaling messages requiring different types of remediation. For example, port 5060 is used by communication nodes using software requiring no remediation at all (i.e. in conformance with the SIP PRS of the SMA). Port 5070 is used by communication nodes requiring remediation only for REGISTER messages. Port 5071 is used by communication nodes requiring remediation for INVITE messages. Port 5080 is used by communication modes requiring remediation for both REGISTER and INVITE messages. All communication nodes upon being introduced to the network are configured by the end-user or the network administrator 175 or some automated means with the IP address of the SMA 130 and the correct port number that would ensure that messages sent to the SMA 130 received the desired remediation.

In one embodiment of the invention, the SMA 130 has a means for retrieving the protocol information from the CN 105 itself and then populating the CN Database 155. In another embodiment, the CN Database 155 is accessed using an administrative tool having a drop-down menu listing the certified protocol variants that have been approved for use. A method is available for selection of the correct protocol variant from an approved list of variants in order to populate the field in the CN Database 155.

In one embodiment, the Protocol Mediation Processor 165 then constructs the signaling messages to be transmitted to the destination communication node. It begins by querying the Protocol Database 160 regarding the incoming message structure and the structure required by the outgoing message. To reduce the number of queries that the PMP 165 makes to the Protocol Database 160, it is useful to develop a look-up table in local memory for quickly determining which signaling messages need remediation. An example of a look-up table is: for a particular protocol variant identified as SIP 2.0 5.3.1 (meaning base protocol is SIP 2.0, vendor #5, release 3.1 by that vendor), the notation “SIP 2.0 5.3.1: REGISTER, REFER” indicates that for that protocol, only REGISTER and REFER messages require remediation, and all other messages do not require remediation. The Protocol Database 160 has a detailed record of the specification for each protocol variant that has been certified for use on the private network 120. The specification is sufficiently complete that the PMP 165 can query the Protocol Database 160 for all information it needs to construct outgoing messages in conformance with the protocol variant. In another embodiment, the look-up table entries are based on the source address (IP address and/or port number) or destination address (IP address and/or port number) to determine which signaling messages require remediation. The PMP may also construct responses to messages as specified by the reference protocol.

In some embodiments that require high speed processing, there is a local cache of the rules for mediating certified protocol variants in the PMP 165. In this implementation the rules for constructing outgoing messages are stored locally in high-speed memory so that messages are constructed as rapidly as possible.

2. Node to Node Communication and Registration

It is one objective of this invention to enable different variations of the signaling protocol to interoperate with each other.

In some embodiments, the SMA 130 receives both registration messages and connect messages from communication nodes (CNs 105) connected to the private network 120. The SMA 130 uses the registration messages to register and authenticate the CNs 105 by querying the User Database 145. The SMA 130 then determines which internal or external communication services the CN 105 is authorized to use by querying the Services Database. The SMA 130 then queries the CN Database 155 to determine which communications protocol variant the CN 105 uses. The SMA 130 also determines if the CN's 105 signaling is interoperable with the signaling of the destination communication node. If the signaling is not interoperable, the SMA 130 instructs the PMP 165 to modify the signaling as required to ensure interoperability. The SMA 130 then forwards registration requests to other registration agents, for example other SMAs, on the private network 120 or registration agents on the external network 125. The registration agents then register the internal communication nodes for access to services under the control of those agents. For example, one external registration agent may support communications to or from a cellular telephone network. Such a registration agent would perform functions similar to or equivalent to those of a cellular networks Visiting Location Registrar (VLR). Other examples are a registration agent that supports services to or from a VoIP service providing connections to the wireline public telephone network or a registration agent that supports audio conferencing services. The SMA 130 may modify the language, format, and syntax of these registration requests as required for communication with the registration agents.

As the SMA 130 may be responsible for forwarding registration in behalf of multiple CNs 105, it is understood that registrations requests can be forwarded in batches wherein registrations for a number of CNs are updated periodically, or forwarded individually wherein a registration request is made in behalf of a single CN.

Once registered, a CN 105 is able to communicate with other CNs on the network and use services it is authenticated for. If the CN 105 was registered with registration agents on external networks 125, it has access to services those registration agents are responsible for as well.

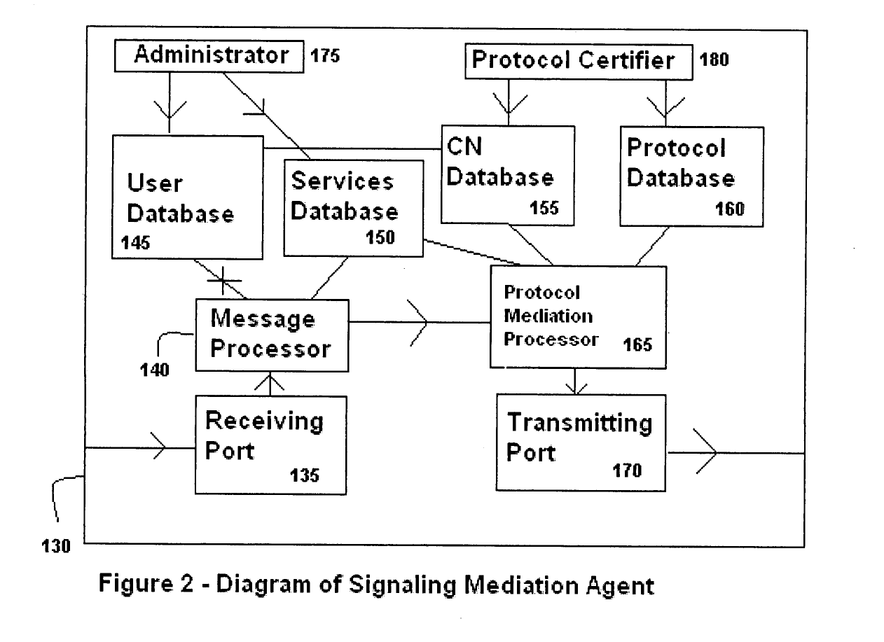

FIG. 2 is a block diagram of an embodiment the SMA 130. The incoming signaling messages from each communication node arrive at the SMA 130 in the format of the specific signaling variant used by the software installed on the communication node sending the signaling message. The incoming message is received by the port 135 of the SMA 130 and passed to a Message Processor 140. If the message is a registration request the Message Processor 140 queries the User Database 145 and the Services Database 150 before passing the message to the Protocol Mediation Processor 165 along with instructions on how to process the message. Such instructions may include, but are not limited to, accept the message or reject the message. If the message is not a registration request, the MP 140 may not query the User Database 145 or the Services Database 150 (e.g. when processing a Disconnect message. Based on the identity of the communication node, the PMP 165 queries the CN Database 155 to determine which communication protocol and which variant of that protocol the originating CN 105 is using. Based on the destination, the PMP 165 then queries the CN Database 155 to determine which specific protocol and protocol variant is required by the communication node which receives the communication signal. The PMP 165 then consults the Protocol Database 160 to determine what protocol modifications need to be applied. The PMP 165 then creates a modified version of the signaling message, and forwards it to the SMA 130 transmitter for transmission to the destination node. In one embodiment, the User Database 145, Services Database 150, CN Database 155, and the Protocol Database 160 are contained within the SMA 130.

### EXAMPLES OF EMBODIMENTS OF THE PRESENT INVENTION INCLUDE

### Example 1

The originating node, Communication Node 1 (CN1) uses TCP for all signaling messages. The destination node, Communication Node 2 (CN2), uses UDP.

The SMA 130 receives the message and authenticates CN1 for the service requested. The Message Processor then passes the message to the Protocol Mediation Processor 165. The PMP 165 then queries the CN Database 155 to determine which protocols CN1 and CN2 use. Because CN1 uses TCP and CN2 uses UDP, a conversion is required. The PMP 165 then looks up the TCP-to-UDP conversion rules in the Protocol Database 160 and converts the TCP message sent by CN1 to UDP. Then the PMP 165 forwards the message to the Transmitting Port, which send the message to CN2. When CN2 replies, the process occurs again, but the conversion goes from UDP to TCP.

### Example 2

The originating node (CN1) sends a signaling message to the SMA 130 using the SIP REFER method defined by RFC 3515. Some communications services, such as external communications services, may not allow the REFER method. Based on the destination IP address the Protocol Mediation Processor 165 queries the Protocol Database 160 and determines if the REFER method is allowed. If allowed, the PMP 165 constructs a modified signaling message in conformance to the specification provided by the Protocol Database 160 for the communication node being communicated to. If the REFER message is not allowed, the SMA 130 can take other actions such as, but not limited to: constructing a signaling message for CN1 using a SIP Response Code such as 5xx or 6xx indicating the signaling has not been completed. Additionally, the SMA 130 can send an IM to the client indicating that the REFER method is unacceptable to the receiving network. Or alternatively, the SMA 130 can redirect the call to an IVR that would play a voice message indicating “The requested call transfer is not allowed by the external network 125.”

### Example 3

RFC 3581 defines an extension to SIP for Symmetric Response Routing(SRR) that enables responses to SIP requests to successfully pass through NAT devices. Some communication nodes may support SRR extensions and other may not. If one of the nodes involved in the communications is external to the private network 120 and on the other side of a NAT device, the Protocol Mediation Processor 165 must determine by a query to the Protocol Database 160 whether the originating node (CN1) and terminating node (CN2) are using SRR or not. If they are both using SRR, no mediation is required. If the external node uses SRR and the internal node does not, the PMP 165 makes the required changes to the signaling message.

In one embodiment, the SMA 130 also determines which protocol or variant is being used by a source CN 105 by listening on a specific port or IP address for messages.

An example of using signaling addresses to identify protocol variants is: a node using SIP 2.0 base protocol in complete conformance with the PRS of the SMA 130 may use port number 5060 for sending and receiving signaling messages. Nodes using variant number N of SIP would use port 5060+N to send and receive signaling messages where N=1, 2, etc.

In another example, the IP address alone is used. Nodes using the base protocol are assigned IP addresses 192.168.1.xyz where “xyz” being a number between 1 and 255. Nodes using protocol variants, identified by a number “abc” where “abc” is a number between 1 and 255) would be assigned an IP address: 192.168.abc.xyz.

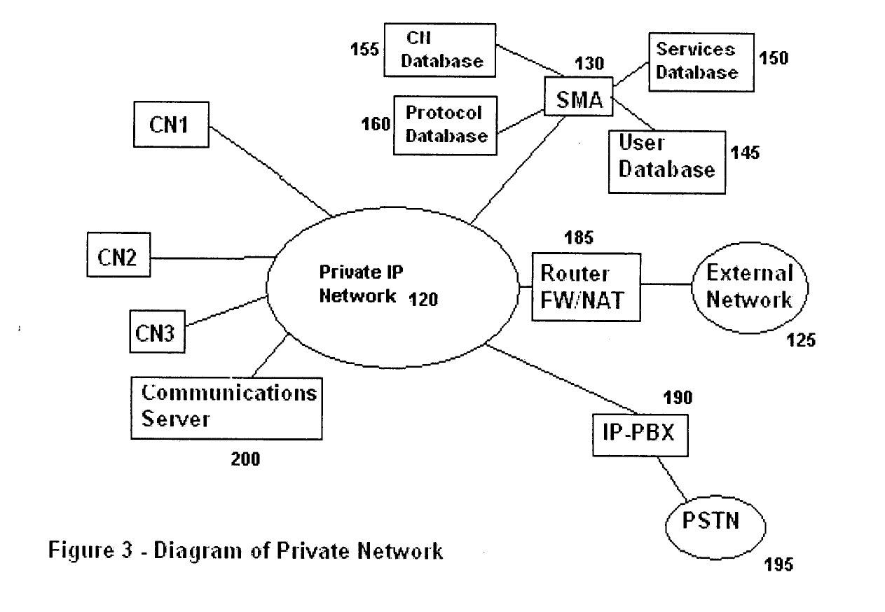

FIG. 3 illustrates a network view of an embodiment of a SMA-enabled system wherein the User Database 145, Services Database 150, CN Database 155, and the Protocol Database 160 are not contained within the SMA, but rather are separate components external to the SMA 130.

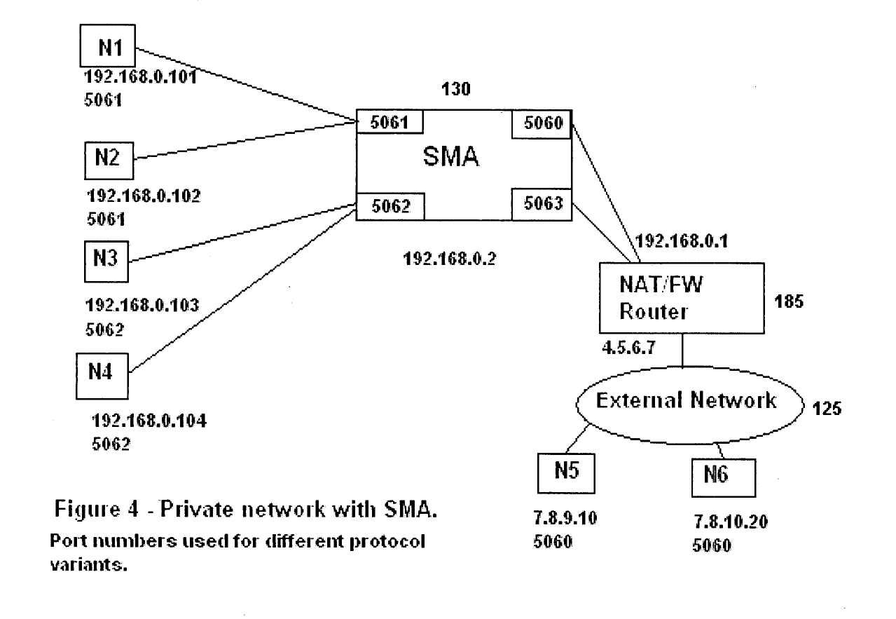

FIG. 4 shows a private network 120 with an SMA, four SIP nodes, N1, N2, N3 and N4 and an external network 125 with two SIP nodes, N5 and N6. Nodes N1 and N2 use SIP variant 10 and are configured to send and receive signaling messages on port 5061. Nodes N3 and N4 use SIP variant 20 and are configured to send and receive signaling messages on port 5062. External Nodes N5 and N6 use protocol variant 30 and receive signaling on port 5060. The private network 120 and the external network 125 are connected by an integrated NAT/Firewall/Router device 185. The NAT 185 translates between the internal IP addresses and the external address 4.5.6.7. The SMA 130 converts among protocol variants 10, 20, 30 and listens for SIP messaging on ports 5060,5061,5062,5063. The SMA 130 has been configured so that if it receives a message on ports 5061,5062, or 5063, that message then conforms to protocol variant 10, 20 and 30, respectively. Furthermore, the SMA 130 has been configured so that if the port address of the destination node is 5060,5061,5062 it constructs the outgoing message in conformance with protocol variant, 30, 10 and 20, respectively. The SMA 130 is configured to recognize that any external node in the 7.8.x.y IP address space uses SIP variant 30. The SMA 130 may provide all the standard functions of a SIP proxy. External nodes can include communications nodes, communications servers, SIP proxies, back-to-back user agents, or other agents that process signaling messages

In this case, the SMA 130 uses only one physical port for all communications, the four TCP ports shown are virtual ports all associated with the same physical port and IP address 192.168.0.2.

In one embodiment, for a CN 105 to register with a services registration agent such as a SMA 130, the following steps occur. It is understood that this is a series of steps for a particular embodiment and other embodiments may rearrange the order or require fewer steps or additional steps while still operating within the spirit and scope of the present invention:
1. A communication device registers on the IP network and receives an IP address by means of IP address assignment (e.g. DHCP or static assignment).
2. A CN 105 hosted on that device sends a registration request to a SMA 130 to register for one or more communications services.
3. The SMA 130 queries a User Database 145 and authenticates the CN. If the authentication is successful, the SMA 130 enters into the User Database 145 information about the CN 105 comprising IP address, Ethernet address, public and private telephone addresses, SIP URIs that are associated with the CN 105 originating the request.
4. The SMA 130 queries a Services Database 150 to determine which external or internal services the CN 105 is authorized to use.
5. The SMA 130 determines whether it needs to send registration requests to other communication nodes that provide access to either services local to the private network 120 or services external to the private network 120, in response to the query to the Services Database. In some embodiments, these registrations may require the SMA 130 to make periodic updates.
6. Information concerning the protocol variant used by the CN 105 must be entered into the CN Database 155. This could be a manual process carried out by the end-user or network administrator 175 or an automated process.
7. The SMA 130 forwards the registration request to a Protocol Mediation Processor 165 with instructions as to which additional registration agents must be contacted. The PMP 165 sends a protocol identification request to a CN Database 155 and determines which variants of the protocol are used by the originating CN 105 and by the destination CN 105, the latter, in this case, is the registration agent for the desired communications service.
8. Once the identity of the two protocol variants is determined, the protocol mediation processor queries the Protocol Database 160 and creates a modified signaling packet based on knowledge of the protocol variant required by the destination registration agent.

The PMP 165 forwards the messaging packet to the SMA's transmitter and then into the private network 120 for transmission to the destination IP address.

Nodes that are registered and authenticated on the private network 120 are allowed access to certain communications services. In one embodiment, a node is authenticated only for services provided by communication nodes on the private network 120. Such “local services” include, but are not limited to, instant messaging, VoIP communications between nodes, video communications between nodes, access to an IP-PBX 190 or a PBX, or a voice messaging service, or a conferencing bridge attached to the private network 120. A node may also be authenticated for external services, such as: a cellular service provider's services; a wireline service provider's VoIP services; access to enhanced services such as an external conferencing or messaging service, or an external PBX service.

3. Node Access to Services

Once the device has obtained an IP address, any CN 105 hosted on the device registers for communications services. In the present invention, the CN 105 registers for these services by communicating with an SMA 130 which assists the CN 105 with registration for communications services and with communications with other CNs on the private network 120 or other CNs on an external network 125.

Several examples are given below:

Example 1: Services are divided into two classes, local service provides by nodes attached to the private network 120, and external services provided by communication nodes attached to external networks 125.
Local Services: SIP, IM, IP-PBX 190
External Services: Ace Cellular, Acme Conference bridge services
These services comprise:
SIP: VoIP or video connections provided by a local SIP Proxy
IM: instant messaging connections provided by a local IM server
IP-PBX 190: voice connections to the public telephone network or locally attached digital telephones, or IP phones registered to the IP-PBX 190, and any other services mediated by the IP-PBX 190.

Ace Cellular: able to send and receive messages from the Ace Cellular network delivered to the communication node over an external network 125 connected to the private IP network.

Acme Conferencing: authorized to connect to an Acme conferencing service over an external network 125 connected to the private IP network.

In one embodiment, each communication nodes listed in the database would have an “L”, an “E”, an “LE” or a null “0” entry indicating respectively whether the node was authorized to receive local, external, both local and external, or no services.

In a second example, all registered devices may be authorized to use all communications services available on the private network 120, but only specific list of communication nodes can access services external to the private network 120. That is each communication node listed would have either an “E” or a null “0” entry

In a third example, services available to a communication node would be designated by the domain name or IP address or both of the communication server responsible for that service and the TCP port number which must be used to send signaling messages to that server:

| | |
|---|---|
| SIP1.mycompany.com | 192.168.10.20: 5060 |
| IM1.mycompany.com | 192.168.10.22: 5060 |
| PBX1.mycompany.com | 192.169.20.01: 5061 |
| PBX2.mycompany.com | 192.168.20.02: 5062 |
| Bridge1.acmeconf.com | 4.2.123.124: 8020 |
| VLR.acecellular.com | 17.23.75.62: 9020 |

After a communications device has obtained an IP address, each communication node hosted by that device registers for specific communications services. The CN 105 can accomplish this registration by sending a registration request, as specified by a communications protocol such as H.323 or SIP or by some variant of these protocols or by a proprietary registration protocol, to the SMA 130. The SMA 130 queries a User Database 145 to verify that the password or authentication data presented for that username is valid. Authentication may require exchange of additional messages and information between the CN 105 and the registration agent as required by the authentication protocol. Once the registration request has been authenticated, the SMA 130 enters the CN's IP address or IP address and port number for signaling, and other information concerning the newly registered communication node in the database of active and authenticated users on the private network 120. This database is the User Database.

To complete the registration process, the SMA 130 must determine which services the CN 105 is authorized to use and ensure that the CN 105 is registered for such additional services. In some cases no additional registrations may be required. In yet other cases successful authentication may automatically convey authorization for one, several or all communications services.

After the communication node has been registered and authenticated on the private network 120 and has had its private IP address and other information recorded in the User Database, the Message Processor 140 queries the Services Database 150 to determine which local and which external services the communication node is authorized to use. For each such communications service, the Services Database 150 contains data for the IP address and the port address to which registration and other signaling messages should be sent.

Based on the results of that query, the SMA 130 then sends registration requests to other SMAs 130 or registration agents attached to the private network 120 or to external networks 125. These registration requests are built by the Protocol Mediation Processor 165 to ensure that they are constructed using the correct protocol format required by each registration agent and that the fields in the registration message are populated with the correct user information.

These other SMAs 130 or registration agents control access to either internal or external communication services. These other agents receive the registration request, password or authentication data, or other address or identity information, compare such information against a database of communication nodes which are authorized to use said communication services, and determine if the communication node (CN) requesting registration is authorized to receive a set of communications services. If the requested registration can be verified and authenticated, the external registration agent signals back to the SMA 130 that registration has been successfully accomplished.

If the other SMA 130 or registration agent is controlling access to an internal service, the network administrator 175 may choose to forgo the need for a second registration for a particular internal service. Alternatively, certain communication nodes, such as IP-PBXs 190 may require a direct registration for access to that node regardless as to whether they reside on the same private network 120 or not.

Signaling for Registration to Receive Communication Services

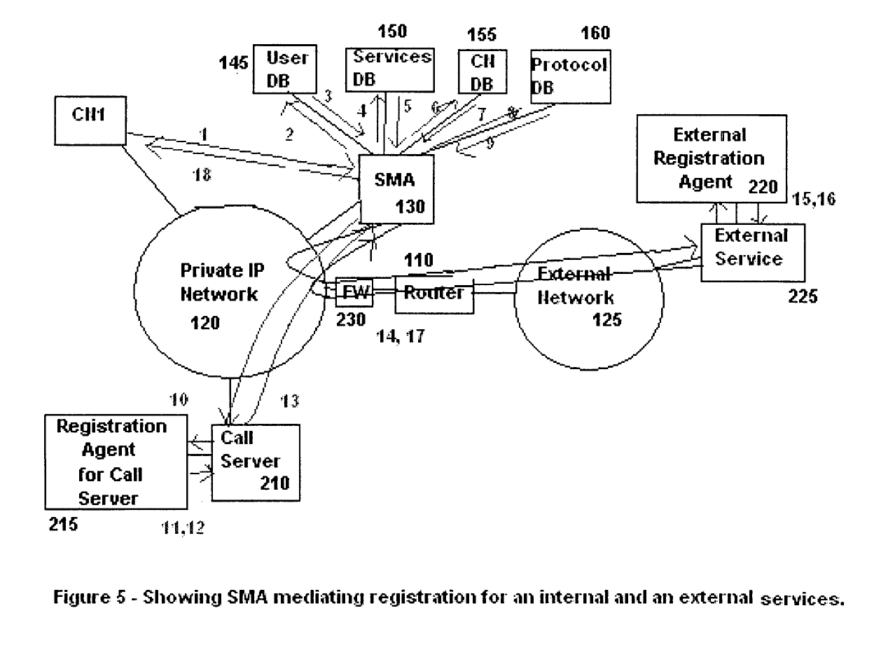

FIG. 5 shows the following sequence of signaling messages:
1 CN1 sends a registration request to the SMA 130.
2 The SMA 130 queries the User Database 145 to authenticate CN1 and receives 3 authentication for the user.
4 The SMA 130 queries the Services Database 150 and determines 5 that CN1 is authorized to use the internal call server 210 and the external service 225.
6 The SMA 130 queries the CN Database 155 and determines 7 which protocol variants are used by CN1 and by the two services, and which signaling addresses to use.
8 The SMA 130 queries the Protocol Database 160 and determines 9 how to construct signaling messages for communicating to the internal Call Server 210 and the External Service 225.
10 The SMA 130 sends a registration request to Call Server 210.
11 The Call Server 210 queries its registration agent and determines 12 if CN1 is authorized.
13 The Call Server accepts or rejects registration request for CN1.
14 The SMA 130 sends a registration request to External Service 225.
15 The External Service 225 queries its registration agent and determines 16 if CN1 is authorized.
17 The External Service 225 accepts or rejects the registration request for CN1.
18 The SMA 130 signals CN1 that registration requests have been accepted or rejected.

Those skilled in the art will recognize that there may be additional intermediate steps in this process requiring acknowledgments or exchange of additional information between the various nodes and or databases. The figure shows only one simplified version of such a sequence of signaling messages.

Signaling for Communication Services

Summary of Steps for Connection Request by a Node on the Internal or External Network 125 for one embodiment
1. CN 105 sends a Connection request to the SMA 130 for Connection to a Communication node on either the internal network or on an external network 125 or to a service on either the internal network or the external network 125.
2. The SMA 130 queries the Services Database 150 to determine if the internal node is authorized to make such a connection. If the request is for an internal connection, the SMA 130 may or may not query the Services Database 150 depending on the type of connection so requested and the policy of the network administrator 175.
3. If the connection request is authorized, the SMA 130 sends a protocol identification request to the CN Database 155 and determines which variants of the protocol are used by the originating CN 105 and the destination CN. A subset of this information may be stored locally at the SMA 130. Alternatively the SMA 130 may be able to determine the protocol variant based on the signaling addresses being used to transmit and receive messages by the communication nodes.
4. Once the identity of the two protocol variants is determined, the protocol mediation processor looks-up and determines if the two communication nodes are interoperable for this particular communications request. The protocol mediation processor creates a modified signaling packet based on knowledge of the two protocol variants involved and forwards the modified packet to the SMA's 130 transmitter 170.
5. The SMA 130 transmits the modified packet to the private network 120.
   4. NAT/Firewall Traversal

In one embodiment, the SMA 130 sends communication signals from the private network 120 to an external signaling agent. These transmissions provide information to the external agent that facilitates transmission of signaling across a firewall or NAT system that may exist between the private network 120 and the second CN.

Many private networks 120 use private IP addresses as defined by RFC 1918 and use a Network Address Translation (NAT) device 115 to translate between private IP addresses and port numbers used on the private network 120 and other IP addresses and port numbers used on an external network 125. In this discussion the term NAT will be used to refer to both basic NAT (IP address translation) and NAPT (IP address and port translation).

NAT creates several problems for communications between a node on the internal network and a node on the external network 125:
(1) The internal node will not automatically know what external signaling address an external node should use to send the internal node a signaling message. It is of no value to the external node if the contact address is an RFC 1918 address which is not routable on the external network 125.
(2) Addresses that are provided in a message body for exchange of communications media, such as contained in the SIP Session Description Protocol (SDP) message, are not useful if the addresses contained in the SDP are private IP addresses and port numbers.

For example, in the SIP protocol (RFC 3261) incorrect private address information would appear in the Via header, the Contact header, and the media addresses given in the SDP message.

To overcome these issues various standards are being developed such as:
(1) RFC 3489—STUN—Simple Traversal of User Datagram Protocol (UDP) Through Network Address Translators (NATs). This RFC enables a client to discover if it is behind one or more NATs and to determine how its signaling address appears to an external network 125.
(2) Universal Plug and Play (UPnP) Forum is creating a set of standards that enable devices to interoperate. If the NAT device and the client software both support UPnP then the client is able to query the NAT and to determine its external IP address and port numbers so that it can include the external addresses in signaling messages to nodes on external networks 125.
(3) RFC 3581 is An Extension to the Session Initiation Protocol (SIP) for Symmetric Response Routing. It allows clients to insert a new field that facilitates firewall traversal as described below:

The Session Initiation Protocol (SIP) operates over UDP and TCP, among others. When used with UDP, responses to requests are returned to the source address the request came from, and to the port written into the topmost Via header field value of the request. This behavior is not desirable in many cases, most notably, when the client is behind a Network Address Translator (NAT) 185. This extension defines a new parameter for the Via header field, called “rport”, that allows a client to request that the server send the response back to the source IP address and port from which the request originated.
(4) Middlebox Communication

The Internet Engineering Task Force is developing a new protocol called the MIDCOM Protocol whose architecture is described in RFC 3303. This protocol will allow an agent, such as a SMA, to control a middlebox such as a NAT 185 or Firewall. Such a protocol would enable the SMA 130 to facilitate the passage of signaling messages and media streams through NAT and firewall devices.

In addition to these methods for facilitating the traversal of NATs there may be other proprietary methods or other future standards not yet developed. The problem is that different communications nodes on a private network 120 may support different methods or no methods. One objective of the present invention is to enable the Signaling Mediation Agent to manage firewall and NAT traversal on behalf of the communication nodes on the private network 120.

Signaling Addresses

In the present invention, the SMA 130 acts on behalf of internal communication nodes to insure that signaling messages are able to pass through the NAT and firewall. The SMA 130 uses either one of the known methods such as, but not limited to, UPNP or STUN to learn the external IP address and port number that the NAT and Firewall devices 185 will present to the external network 125 for receiving signaling messages from an external node.

In one embodiment for example, the SMA 130 uses internal address 192.168.0.2: 5090 to receive signaling messages from external communication nodes. The NAT device 185 translates this to an external address 4.5.6.7:8662. As described above, the SMA 130 learns this mapping and ensures that any outgoing signaling messages provide the external address 4.5.6.7:8662 in the address fields specifying the return signaling address that an external node must use to signal to an internal node.

As the SMA 130 may use different IP address or different port numbers or both for signaling based on different protocols or different protocol variants which are used by internal nodes or by external nodes, the SMA 130 must discover the external IP address and port number for each of the signaling addresses it employs for communicating to nodes on the external network 125. While these addresses could be automatically discovered using a standard such as STUN or UPnP, they could also be directly controlled and configured by the network administrator 175.

In one embodiment of this invention, the SMA 130 learns the external IP address(s) and port number(s) an external node should use to communicate with the SMA 130 acting on behalf of an internal node. The SMA 130 learns these addresses and enters these addresses in the connect messages on behalf of the internal node. The SMA 130 may also enter these addresses in a database.

For example, to communicate with the SMA 130 each external service may use a specified external address and port number as the destination address for reaching the private network 120 in order to initiate communications with nodes on the private network 120. This external address is entered into the Services Database. In addition, this external address would be provided in any registration message sent to an external registration agent acting on behalf of a communications service.

As an example if there are two external services, Service A and Service B, address 4.5.6.7:8662 may be used as the signaling address provided to Service A and 4.5.6.7: 8884 may be used as the signaling address provided to Service B. The NAT device 185 will map these addresses as follows:

| | Internal Address | External Address |
|---|---|---|
| Service A | 192.168.0.2: 5090 | 4.5.6.7: 8662 |
| Service B | 192.168.0.2: 5092 | 4.5.6.7: 8884 |

For outgoing signaling message to Service A, the SMA 130 will insure that return signaling is provided according to the Table and that the signaling protocol variant used to construct the signaling message is built using the protocol variant required by Service A, as determined by the SMA 130 by querying the Communications Node Database.

If the base protocol is SIP 2.0, then these signaling addresses also get entered in the Via header, the contact header field, and the SDP message connection field. The SMA 130 would make these modification acting in behalf of communications nodes on the private network 120.

Media Addresses

To provide the correct signaling address for the external node to use in sending signaling messages to the private network 120, it is necessary to provide a correct address that an external node must use for sending the RTP media defined by the Real-Time Transport Protocol, RFC 1889 to an internal communication node.

In one embodiment of this invention, the SMA 130 will act on behalf of the internal communications node to open a “pinhole” in the NAT/Firewall that enables traversal of the RTP media. “Pinhole” refers to the fact that a single port is opened in the firewall of limited temporal duration for the purpose of allowing RTP media to pass through the firewall for the desired communication service and remains open for the duration of that communication session. When the SMA 130 receives a connection request message either from an internal node or from an external node, the SMA 130 will signal the NAT/Firewall 185 device to open a pinhole for the purpose of allowing RTP media to pass through the NAT/Firewall 185 for said communication. The NAT/FW 185 will bind an external IP address/port number combination to the internal node's IP address and translated port number. The SMA 130 will determine and record the internal and external address information for each session, and enter this address information in any signaling messages that require address information for either incoming or outgoing RTP media.

Alternatively, if no direct signaling means exist for the SMA 130 to open a pinhole in the firewall, the SMA 130 can open a pinhole in the NAT and Firewall by sending “spoofed” UDP packet to an external node that has been established to facilitate the creation of pinholes. The spoofed packet uses the internal IP address of the internal communications node and the media port provided by the internal client in its connection message as the source address, rather than the SMA's 130 own IP address as the source address. The spoofed packet uses as the destination address the IP address of the external communications node. The spoofed packet serves to open a pinhole in the Firewall and establish a mapping between an internal address and an external address.

The SMA 130 queries the NAT device 185 to determine the mapping between the internal address (IP and port number) and the external address (IP and port number). Or alternatively the external node will communicate the external IP address back to the SMA 130.

In the case of SIP, the external address of the pinhole to be used for a communications will be entered by the SMA 130 into the SDP message of the outgoing signaling message participating in the establishment of that communications session.

Summary of Steps for Connection Request to a Node on an External Network 125 if there is a NAT on the path:
1. CN 105 sends a Connection request to the SMA 130 for Connection to a Communication node on an external network 125.
2. The SMA 130 queries the Services Database 150 to determine if the internal node is authorized to make such a connection to the external node
3. If the connection request is authorized according to the Service Database, the SMA 130 sends a protocol identification request to the CN Database 155 and determines which variants of the protocol are used by the originating CN 105 and the destination CN. A subset of this information may be stored locally at the SMA 130 and updated periodically. Alternatively the SMA 130 may be able to determine the protocol variant based on the signaling addresses being used for communications to the internal node and the external node.
4. Once the identity of the two protocol variants is determined, the protocol mediation processor may do a look-up and determine if the two communication nodes are interoperable for this particular communications request. The protocol mediation processor creates a modified signaling packet based on knowledge of the two protocol variants involved.
5. The protocol mediation processor must also insure that signaling can pass successfully through a NAT that may be on the path between the internal network and the external network 125. The PMP 165 will need to change any address information in the signaling message referring to internal addresses on the private and replace internal IP addresses with the external IP address on the router that provides connection to the external network 125. The PMP 165 may also need to change any signaling port address that is specified in the signaling message. The SMA 130 may need to use an address discovery protocol such as STUN or a proprietary protocol to determine which IP address and port number should be provided in the signaling message.
6. The SMA 130 transmits the modified packet to the private network 120

### Example

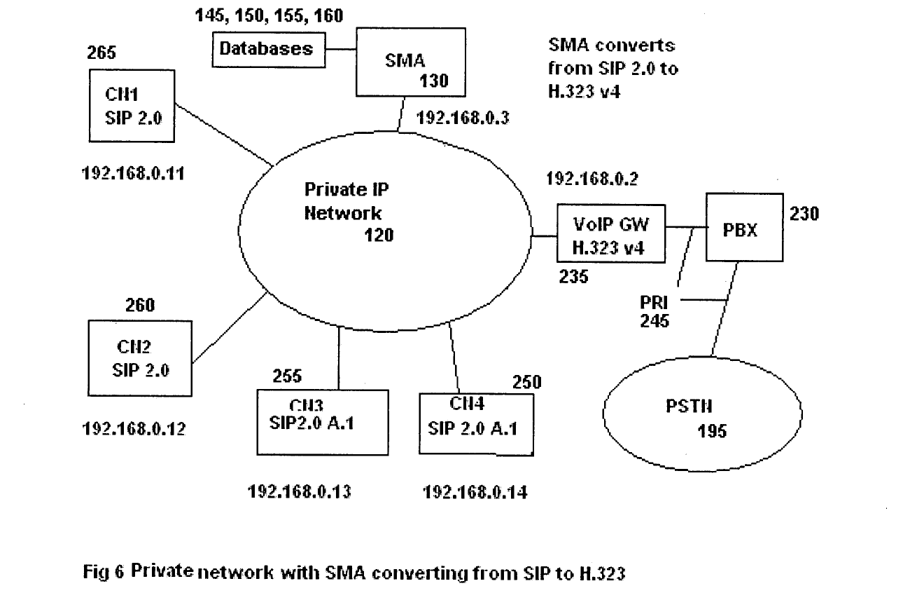

FIG. 6 shows five communication nodes attached to an IP network 120. CN1, CN2, CN3, CN4 are communication nodes, such as PCs, that have VoIP clients. The clients on CN1 and CN2 have a client application that uses protocol SIP 2.0 that conforms to the reference SIP protocol of the SMA 130. The clients on CN3 and CN4 use a client application that uses protocol SIP 2.0 A.1 provided by Vendor A. In addition, there is an IP-PSTN gateway 235 that uses protocol H.323v4 on the IP-side and primary rate ISDN (PRI) on the PSTN 195 side. The gateway connects the IP Network 120 to a PBX 230. The PBX 230 in turn connects to the PSTN 195 to provide PSTN access for the gateway 235 and CNs that can communicate with the gateway 235. The SMA 130 attaches to the IP network and converts between SIP 2.0 reference, SIP 2.0 version A.1 and H.323v4. The IP network provides the CNs two communication services: (1) connection between CNs (VoIP); (2) connection to the PSTN 195 (pstn access) through the VoIP gateway 235 and PBX 230.

The SMA 130 connects to a database that contains all the required information. Included in the database would be a Table listing the node name, the node's IP address and the protocol variant used by that node.

| | | |
|---|---|---|
| VoIP gateway | 192168.0.2 | H.323v4 |
| CN1 | 192.168.0.11 | SIP 2.0 ref |
| CN2 | 192.168.0.12 | SIP 2.0 ref |
| CN3 | 192.168.0.13 | SIP 2.0 A.1 |
| CN4 | 192.168.0.14 | SIP 2.0 A.1 |

The database contains all information that is needed to authenticate the identity of each node for authorization including username and password.

The database contains a table identifying which services each node is authorized to use. In this example only CN1 and CN2 are authorized to have PSTN access.

| | |
|---|---|
| VoIP gateway | VoIP, pstn |
| CN1 | VoIP, pstn |
| CN2 | VoIP, pstn |
| CN3 | VoIP |
| CN4 | VoIP |

The database contains all information the SMA 130 needs to be able to convert among the three protocols it supports. In this example, SMA also performs the standard signaling functions of both a SIP proxy and an H.323 signaling routed gatekeeper.

1. A method for permitting communications between a first communication node and a second communication node, comprising:
receiving a signaling message from said first communication node;
querying a first Communications Node Database for information about said first communication node in response to said signaling message;
querying a second Communications Node Database for information about said second communication node in response to said signaling message;
making a decision whether said signaling message needs to be modified; and
modifying said signaling message before it is transmitted to said second node in response to said decision.

2. The method of claim 1 wherein said signaling message is a request to connect, modify, or disconnect communications.

3. The method of claim 1 wherein said communications comprise: Voice over IP; video over IP; instant messaging; access to conferencing bridges connecting multiple communication nodes; and access to communications servers for deposit or retrieval of stored communications.

4. The method of claim 1 wherein said signaling message comprises a registration request; an authentication request; a connection request, a request to modify a connection, and a request to terminate a connection.

5. The method of claim 1 wherein said step of modifying comprises changing at least one of: a source address; a destination address; a signaling protocol; a signaling method; adding a field; deleting a field; a syntax; a punctuation; a spelling; and said communications signals.

6. The method of claim 1 wherein said first database and said second database are a single database.

7. The method of claim 1 further comprising a step of grouping communication nodes into categories, and
wherein each category requires a different protocol remediation; and
each category uses different signaling addresses for sending messages to a signaling mediation agent.

8. The method of claim 7 wherein said signaling addresses comprise a port number.

9. The method of claim 7 wherein said categories are based on a specified set of signaling messages requiring remediation.

10. A method for authorizing communications between a first communication node and a second communication node comprising:
receiving a registration request message from said first communication node;
querying a first database to authenticate an identity of said first communication node;
querying a second database to determine which communication services said first communication node is authorized to use;
querying a third database for signaling addresses of registration nodes for said authorized communication services;
querying a fourth database for additional information about said registration nodes;
making a decision whether said registration request message needs to be modified in response to querying said first database, querying said second database, querying said third database, and querying said fourth database; and
modifying said registration request message before it is transmitted to said registration node in response to said decision.

11. The method of claim 10 wherein said first database, said second database, said third database, and said fourth database are a single database.

12. The method of claim 10 wherein said communications comprise: Voice over IP; video over IP; instant messaging; access to conferencing bridges connecting multiple communication nodes; and access to communications servers for deposit or retrieval of stored communications

13. The method of claim 10 wherein said communication services comprise: access to cellular networks; access to a PSTN; access to conferencing services; and access to messaging services.

14. A method for permitting communications between a first communications node attached to a first communications network, a second communications node attached to a second communications network, and a network address translation device on an interconnection path between said first communications network and said second communications network, comprising:
receiving, by a signaling agent, a signaling message having an original source address and an original destination address from one of said first and second communications nodes on said respective first and second communications network, a request for communications with an other of said first and second communications nodes on said respective first and second communications networks;
determining, by said signaling agent, said original source address and a translated source address of said signaling message transmitted to said other of said first and second communications nodes by said network address translation device;
inserting, by said signaling agent, in said signaling message from said one of said first and second communications nodes, an external source address for receiving signaling messages from said other of said first and second communications nodes to create a modified message; and
forwarding, by said signaling agent, said modified message to said other of said first and second communications nodes.

15. The method of claim 14 further comprising learning how said network address translation device translates said original source address into said translated source address for messages and making changes to said translated source address provided in said modified message.

16. A method for permitting communications between a first communications node attached to a first communications network, a second communications node attached to a second communications network, and a network address translation device and a firewall device on an interconnection path between said first communications network and said second communications network, comprising:
receiving, by a signaling agent, a signaling message having a destination address, from one of said first and second communications nodes on a respective first and second communications network, a request for communications with an other of said first and second communications nodes on said respective first and second communications networks;
determining, by said signaling agent, an identity of said one of said first and second communications nodes from said signaling message;
querying, by said signaling agent, a database to determine an internal IP address and a port number for signaling one of said first and second communications nodes;
modifying, by said signaling agent, said destination address of said signaling message; and
transmitting, by said signaling agent, said message to said other of said first and second communications nodes.

17. A method for permitting communications between a first communications node attached to a first communications network, a second communications node attached to a second communications network, and a network address translation device and a firewall device on an interconnection path between said first communications network and said second communications network, comprising:
receiving, by a signaling agent, a signaling message from one of said first and second communication nodes on a respective first and second communications network, a request for communications with said other of said first and second communications nodes on said respective first and second communications networks;
sending, by said signaling agent, a request message to said network address translation device and said Firewall device to open a port on said firewall device to allow communications between said first node and said second node to traverse said network address translation device and said firewall device;
opening, by said network address translation device and said firewall, said port on said firewall and establishing a mapping between an internal address of said port and an external address of said port, and providing said mapping information to said signaling agent;
determining, by said signaling agent, said mapping established by said network address translation device of said external address of said communications to said internal address;
storing, by said signaling agent, said mapping information in memory; and
modifying, by said signaling agent, any address information in said signaling messages for said communications so that said one of said first and second communications nodes, learns said external address for sending communications to said other of said first and second communications nodes and said one of said first and second communications nodes learns said internal address to use as said source address for sending communications to said other of said first and second communications nodes.

18. The method of claim 17 wherein said step of opening uses UPnP.

19. A method for permitting communications between a first communication node and a second communication node comprising:
receiving a signaling message from said first communication node;
making a decision whether said signaling message needs to be modified in respect to an originating address used by said first communication node to send said signaling messages; and
in response to said decision, modifying said signaling message, transmitting said signaling message to said second node.

20. The method of claim 19 wherein said originating address comprises an IP address and port number

21. The method of claim 19 wherein said communications comprise: Voice over IP; video over IP; instant messaging; access to conferencing bridges connecting multiple communication nodes; and access to communications servers for deposit or retrieval of stored communications.

22. The method of claim 19 wherein said signaling messages comprise registration requests; authentication requests; connection request, requests to modify a connection, requests to terminate a connection.

23. The method of claim 19 wherein modifying comprises changing at least one of: source address; destination address; changing signaling protocol; changing signaling methods; adding fields; deleting fields; modifying syntax; changing punctuation; changing spelling; altering said communications signals such that said first communication node can communicate without errors or failures with said second communication node.

24. A method for permitting communications between a first communication node and a second communication node, comprising:
receiving, by an agent, signaling messages from said first communication node;
modifying, by said agent, said messages based on a signaling address said agent uses to receive said signaling messages;
wherein said first communication node is configured to use a destination signaling address for sending messages to a signaling agent; and
wherein said destination signaling address is configured on said first node based on a protocol variant used by said first communication node.

25. A method for communicating between a first communication node and a second communication node comprising:
receiving, by an agent, signaling messages from said first communication node;
modifying, by said agent, said messages and
transmitting, by said agent, signaling messages to said second communication node.

26. The method of claim 25 wherein said modifying said messages is based on a signaling address used to receive messages from said first communication node.

27. The method of claim 25 wherein said modifying said messages is based on said signaling address used to transmit messages to said second communication node.
